(19) United States
(12) Patent Application Publication
(10) Pub. No.: US 2006/0161316 A1
(43) Pub. Date: Jul. 20, 2006

(54) Aircraft control system and method

(75) Inventor: Douglas Barret Binder, Penrose, CO (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Estes-Cox Corporation, Penrose, CO (US)

(21) Appl. No.: 11/035,673

(22) Filed: Jan. 14, 2005

(51) Int. Cl. G05D 1/08

(52) U.S. Cl. 701/4

(57) ABSTRACT

Methods and systems for controlling model aircraft are provided. In one aspect, a model aircraft includes a section having a longitudinal axis that extends from a rear of the aircraft to a front of the aircraft, the longitudinal axis being substantially parallel to a surface of the Earth when the aircraft is in level flight, and the aircraft includes a control system. The control system includes a sensor, mounted on the section and having a viewing axis in a first direction that is substantially normal to the longitudinal axis, a controllable mirror constructed and arranged to divert the viewing axis of the sensor to selectively provide an effective viewing axis in at least a second direction that is different from the first direction and a third direction that is different from the first direction and different from the second direction, and a controller coupled to the sensor to receive output data from the sensor and adapted to provide output signals to control attitude of the model aircraft based on the data.

### BACKGROUND OF INVENTION

1. Field of Invention

Embodiments of the invention relate generally to controlling operation of model aircraft, and more specifically to methods and systems for controlling pitch and roll of model aircraft.

2. Discussion of Related Art

In model aircraft, it is desirable to include attitude control systems that monitor and control the attitude of the aircraft, including pitch and roll, to assist in autopilot operations or to prevent an operator from controlling the aircraft in a manner that may increase the likelihood of a crash. Inexperienced operators of remote controlled model or toy aircraft often need assistance in controlling operation of the aircraft, and attitude control systems can be used to help such operators become more proficient at flying the aircraft without worrying about multiple crashes, which can be frustrating and can damage the aircraft.

Infrared sensors have been used in attitude control systems of aircraft. Typically, one or more sensors are positioned on the aircraft to detect the horizon, and in particular a pair of oppositely facing sensors are typically used to detect one of pitch and roll. The attitude of the aircraft can be determined using output data from the sensors along with the principle that the sky is generally cooler than the surface of the earth. Changes in pitch or roll can be detected based on differences in the outputs of a pair of sensors. For example, U.S. Pat. No. 6,181,989, issued to Gwozdecki on Jan. 30, 2001, incorporated herein by reference, discloses aircraft having up to six infrared sensors to detect pitch, roll and whether the aircraft is in inverted flight. With each additional sensor that is added, the cost of the aircraft increases due to the cost of the sensor itself and the cost of associated control electronics that are used with the sensors. In model aircraft, and in particular in toy aircraft, these costs can become so high, so as to prevent designers from including an attitude control system in model aircraft.

### SUMMARY OF INVENTION

Embodiments of the invention provide systems and methods for controlling model aircraft. One aspect of the invention is directed to a control system for a model aircraft having a longitudinal axis that extends from a rear of the aircraft to a front of the aircraft, the longitudinal axis being substantially parallel to a surface of the Earth when the aircraft is in level flight. The control system includes a sensor having a viewing axis in a first direction that is substantially normal to the longitudinal axis, a diverter constructed and arranged to divert the viewing axis of the optical sensor to provide an effective viewing axis in at least a second direction that is different from the first direction, and a controller coupled to the sensor to receive output data from the sensor and adapted to provide output signals to control attitude of the model aircraft based on the data.

In the control system, the diverter may be constructed and arranged to selectively provide an effective viewing axis in a third direction that is different from the first direction and different from the second direction, and the second direction may be along an axis normal to the viewing axis and the third direction may be along an axis normal to the viewing axis. The controller may be configured to determine roll attitude of the aircraft based on data from the sensor. The controller may be configured to determine pitch attitude based on data from the sensor. The diverter may be constructed and arranged to selectively provide an effective viewing axis in a fourth direction and a fifth direction, with the second direction being opposite the third direction and the fourth direction being opposite the fifth direction. The diverter may include a mirror that is rotatable to change direction of the effective viewing axis. The controller may be configured to provide output signals to control position of the mirror. The sensor may include an infrared sensor.

Another aspect of the invention is directed to a method of controlling a model aircraft. The method includes positioning a sensor on the aircraft such that a viewing axis of the sensor is in a first direction, diverting the viewing axis of the sensor to provide a first effective viewing axis in a second direction that is different from the first direction, diverting the viewing axis of the sensor to provide a second effective viewing axis in a third direction that is different from the first direction and the second direction, capturing data from the sensor, and controlling an attitude of the aircraft based on the data.

In the method of controlling a model aircraft, the second direction may be along an axis normal to the viewing axis and the third direction may be along an axis normal to the viewing axis. The method may further include determining roll attitude of the aircraft based on data from the sensor, and determining pitch attitude of the aircraft based on data from the sensor. The method may include diverting the viewing axis of the sensor to provide a third effective viewing axis in a fourth direction that is different from the first direction, diverting the viewing axis of the sensor to provide a fourth effective viewing axis in a fifth direction that is different from the first direction and the second direction, with the second direction being opposite the third direction and the fourth direction being opposite the fifth direction. The method may still further include controlling roll attitude and pitch attitude based on data from the sensor, and the sensor may include an infrared sensor.

Another aspect of the invention is directed to a method of controlling a model aircraft using an infrared sensor mounted to the aircraft and a controllable mirror positioned along a viewing axis of the infrared sensor to control an effective viewing axis of the infrared sensor. The method includes, with the controllable mirror in a first position, detecting infrared energy using the infrared sensor, moving the controllable mirror to a second position, with the controllable mirror at the second position, detecting infrared energy using the infrared sensor, and controlling attitude of the aircraft based at least in part on signals generated by the infrared sensor.

In the method of controlling an aircraft, at the first position, the effective viewing axis may be in a first direction normal to the viewing axis, and at the second position, the effective viewing axis may be in a second direction, opposite the first direction. The method may further include moving the controllable mirror to a third position, with the controllable mirror at the third position, detecting infrared energy using the infrared sensor, moving the controllable mirror to a fourth position, with the controllable mirror at the fourth position, detecting infrared energy using the infrared sensor, and controlling pitch and roll of the aircraft based at least in part on signals generated by the infrared sensor.

Yet another aspect of the invention is directed to a model aircraft. The model aircraft having a section having a longitudinal axis that extends from a rear of the aircraft to a front of the aircraft, the longitudinal axis being substantially parallel to a surface of the Earth when the aircraft is in level flight, and a control system. The control system includes an infrared sensor, mounted on the section and having a viewing axis in a first direction that is substantially normal to the longitudinal axis, a controllable mirror constructed and arranged to divert the viewing axis of the infrared sensor to selectively provide an effective viewing axis in at least a second direction that is different from the first direction and a third direction that is different from the first direction and different from the second direction, and a controller coupled to the infrared sensor to receive output data from the infrared sensor and adapted to provide output signals to control attitude of the model aircraft based on the data.

In the model aircraft, the controllable mirror may be constructed and arranged such that the second direction is opposite the first direction to allow the infrared sensor to obtain infrared images of two opposite horizons when the aircraft is in level flight, and the controller may be configured to determine at least one of pitch attitude and roll attitude of the aircraft. The control system may further include a mirror driver coupled to the controllable mirror to move the effective viewing axis between the first direction and the second direction, wherein the mirror driver is constructed and arranged to rotate the controllable mirror about an axis that is normal to the longitudinal axis. The mirror driver may be constructed and arranged to rotate the controllable mirror to each of four rotational positions separated by approximately ninety degrees. The controller may be configured to determine pitch and roll of the aircraft based on infrared data obtained for each of the four rotational positions of the controllable mirror. The controller may be operatively coupled to the mirror driver to control movement of the controllable mirror. The model aircraft may further include a receiver coupled to the controller to receive signals from an operator to control operation of the model aircraft.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a top view of an aircraft in accordance with one embodiment of the present invention;

FIG. 2 is a side view of the aircraft of FIG. 1;

FIG. 3 is a functional block diagram of a control system for an aircraft in accordance with one embodiment of the present invention;

FIG. 4 is a diagram of components of a horizon sensing system used in at least one embodiment of the present invention;

FIG. 5 is a schematic diagram of components of the horizon sensing system of FIG. 4;

FIG. 6 is a diagram of a mirror assembly used in the horizon sensing system of FIG. 4; and

FIG. 7 is a diagram of a horizon sensing system in accordance with another embodiment of the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

At least one embodiment of the present invention provides an improved attitude control system for a model aircraft that can detect pitch and/or roll of an aircraft using only one infrared sensor. However, embodiments of the invention are not limited to control systems that utilize only one sensor and additional sensors may be added to provide additional detection and control capabilities.

In at least one embodiment described below, a remote controlled aircraft includes an improved attitude control system. Embodiments of the present invention may be used with various aircraft, motorized or non-motorized, including, but not limited to, gliders, hovercrafts, all types of airplanes, including flying wings, and helicopters. Further, embodiments of the invention may be used with remote controlled aircraft or with aircraft that are not remote controlled.

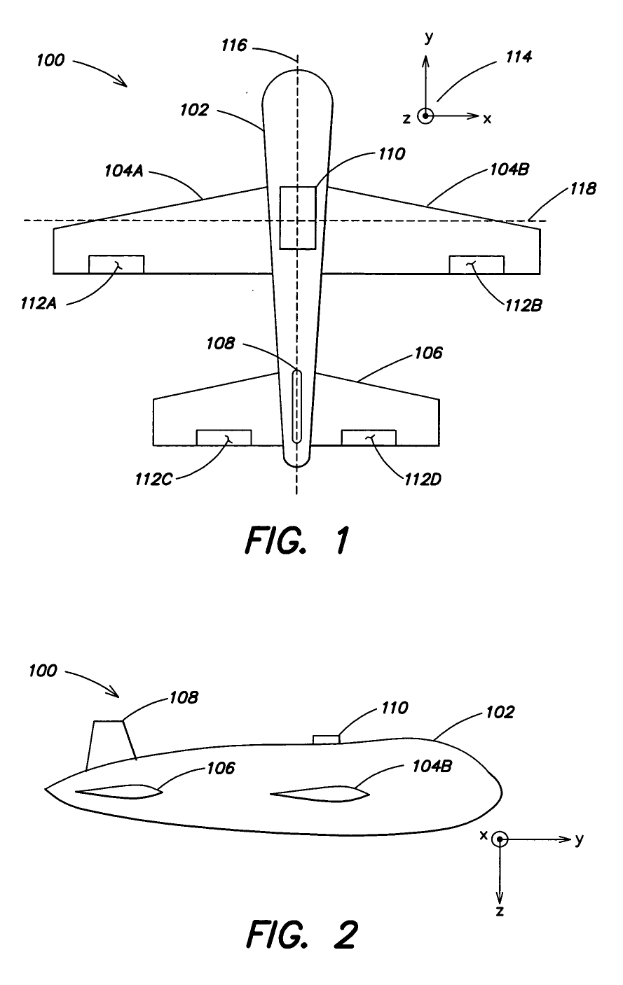

FIG. 1 shows a top view of a model aircraft 100 in accordance with one embodiment of the present invention, and FIG. 2 shows a side view of the aircraft 100. The aircraft 100 includes a fuselage 102, a pair of wings 104A and 104B, a horizontal stabilizer 106, a vertical stabilizer (which may include a rudder) 108, and a horizon sensing system 110. As is well known, but not shown for simplicity, the aircraft 100 may also include one or more motors and propellers, landing gear, and in one embodiment includes control circuitry and one or more batteries contained within the aircraft. The wings include ailerons 112A, 112B and the horizontal stabilizer includes elevators 112C, 112D. The particular number and placement of control surfaces may vary in different embodiments of the invention. Also shown in FIGS. 1 and 2 is a coordinate system 114 that is used below to assist in the description of operation of the aircraft and more particularly the horizon sensing system. A longitudinal axis 116 and transverse axis 118 of the aircraft are also identified in FIG. 1. As described below, the horizon sensing system 110 is used in conjunction with the control circuitry to control the attitude of the aircraft by sensing the horizon using an infrared sensor directed along at least one of the longitudinal axis and the transverse axis.

In one embodiment, the aircraft 100 is a remote controlled aircraft that is responsive to radio control signals received from a remote controller operated by a user on the ground. However, in other embodiments, the aircraft 100 may be controlled using an internal microcontroller, microprocessor or other control circuitry that controls flight of the aircraft in accordance with one or more programmed flight plans. In still another embodiment, the aircraft 100 may be controlled using an internal microcontroller, microprocessor or other control circuitry that controls attitude of the aircraft in flight.

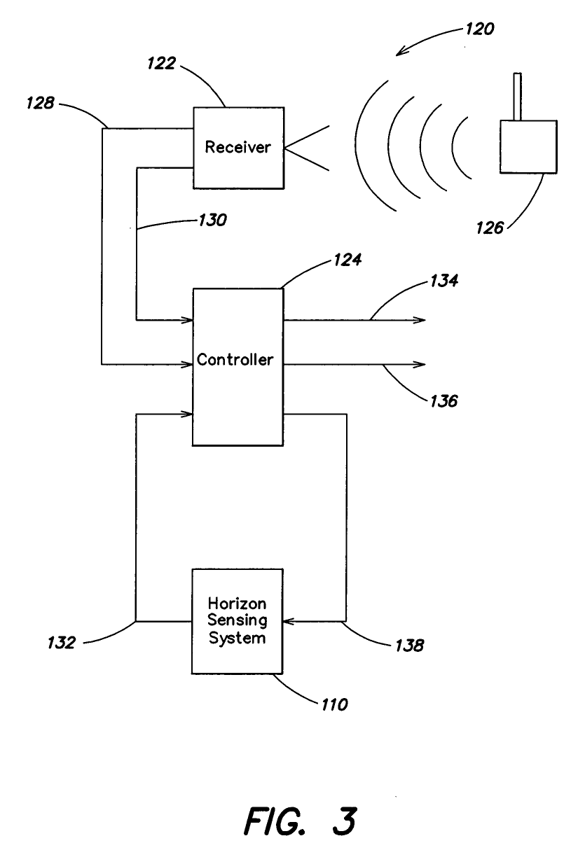

A functional block diagram of a control system 120 for the aircraft 100 will now be described with reference to FIG. 3. The control system 120 includes a receiver 122, a controller 124 and the horizon sensing system 110. The control system also includes a remote control device 126. The receiver provides control signals to the controller over control lines 128 and 130 based on input received from a user through the remote control device 126. The controller also receives attitude data from the horizon sensing system 110 over control line 132. Based on the signals received, the controller provides output servo signals on control lines 134 and 136 to control servos associated with the elevators and/or ailerons and/or rudder to control flight of the aircraft. The controller 124 may also have an output signal to control one or more systems of the aircraft 100. The controller 124 also provides an output control signal on control line 138 to control a viewing axis of the horizon sensing system as described in further detail below. In one embodiment, the controller is implemented using a microcomputer available from Philips under part no. P89LPC904, however other parts or devices may be used as well. Further, the functions of the controller may be implemented using known microcontrollers or logic circuits. Further, the receiver may be implemented using one of a number of commercially available hobby receivers. In FIG. 3, a single line is shown for each of the control lines. In different embodiments, there may be more than one conductor to provide control signals for each of the control lines.

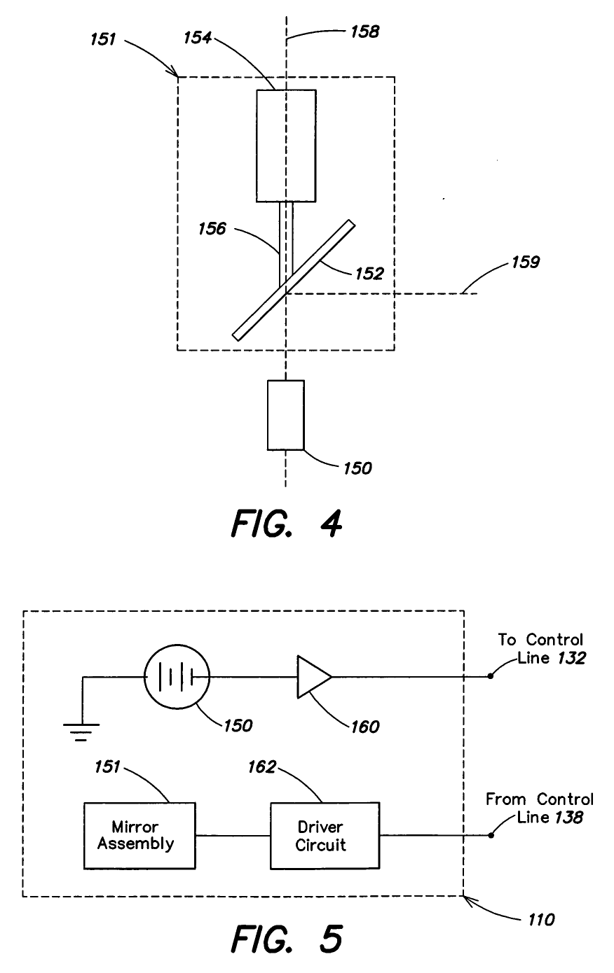

The horizon sensing system 110 will now be described in greater detail with reference to FIG. 4, which provides a diagram showing the relationship of the major components of the horizon sensing system in use, and with reference to FIG. 5, which provides a functional block diagram of the system. As shown in FIG. 4, the system includes a thermal sensor 150, and a mirror assembly 151 that includes a mirror 152, a mirror controller 154, and a rotatable shaft 156 coupled between the mirror controller and the mirror to rotate the mirror about an axis of rotation 158 that passes through the center of the rotatable shaft 156.

The thermal sensor 150 is positioned with respect to the mirror 152 such that the viewing axis of the thermal sensor is aligned with the axis of rotation and in the direction of the mirror. In one embodiment, the horizon sensing system is positioned at the intersection of the longitudinal axis and the transverse axis (see FIG. 1) of the aircraft 100, with the axis of rotation being normal to the transverse axis 118 and normal to the longitudinal axis 116. In the embodiment shown in FIG. 4, the mirror is positioned at a 45 degree angle with respect to the axis of rotation, however, as described below, in other embodiments, the mirror angle may be different. In operation, the mirror is positioned by the mirror controller under the direction of the microcontroller to create an effective viewing axis 159 of the thermal sensor in a direction that is normal to the axis of rotation 158. By rotating the mirror, the effective viewing axis can be aligned with the longitudinal axis 116 and the transverse axis 118 to allow the thermal sensor to selectively detect the horizon at the left side of the aircraft, at the right side of the aircraft, at the front of the aircraft, and at the back of the aircraft. In addition, if desired, the effective viewing axis can be positioned at rotational positions between the transverse axis and the longitudinal axis.

With reference to FIG. 5, the connectivity and additional components of the horizon sensing system 110 will be described. The system 110 includes the thermal sensor 150, an operational amplifier (op amp) 160, the mirror assembly 151 and a driver circuit 162. The driver circuit 162 receives an input from the controller 124, conditions the signal from the controller, and provides an output signal to the mirror assembly circuit to control the position of the mirror. The thermal sensor 150 detects infrared signals and provides an output signal to the operational amplifier 160. The op amp 160 amplifies and conditions the output signal to be compatible with the input of the controller, and in at least one version is configured to provide a gain of 1000. In one embodiment, the thermal sensor is implemented using a thermopile available from Opto Tech, Corp. of Taiwan, under part number TP399UG and the op amp is implemented using an op amp available from National Semiconductor under part no. LM358D. In other embodiments, other devices may be used for the thermal sensor and to provide conditioning of output signals from the thermal sensor.

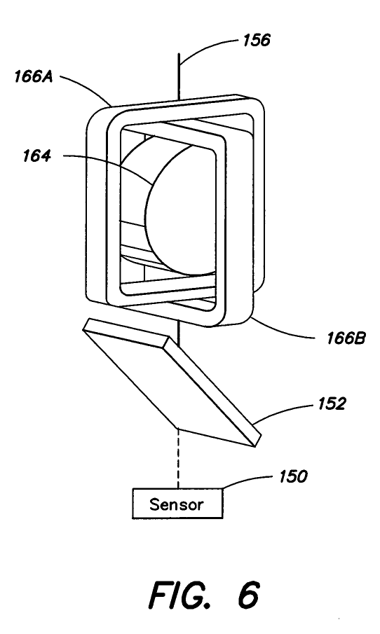

The mirror assembly 151 of one embodiment is shown in greater detail in FIG. 6 and includes a magnet 164, two coil assemblies 166A and 166B, the rotating shaft 156 and the mirror 152. The driver circuit, in response to signals from the controller, provides signals to one or both coil assemblies to cause the magnet to rotate to a desired position. The rotation of the magnet causes the rotating shaft 156 and accordingly the mirror to rotate. In one embodiment, the coils are implemented using 35 ohm coils and the magnet is a neodymium magnet, however, other coils and magnets could be used.

During flight of the aircraft 100, under the control of the controller 124, the thermal sensor can be configured to obtain thermal profiles in the front, back, left side and ride side of the aircraft. The controller is configured to compare thermal profiles of each side to determine roll attitude of the aircraft, and to compare thermal profiles from the front and back to determine pitch attitude of the aircraft. The controller uses attitude data along with control information from either the remote control device or stored instructions to control elevators, ailerons, rudders, other control surfaces, and/or one or more motors of the aircraft to provide desired flight patterns. In the embodiment described, both roll attitude and pitch attitude are determined using the sensor. In other embodiments only one of pitch and roll may be determined.

In embodiments described above, a thermal sensor is used to detect the horizon based on thermal differences between the earth and the sky. In other embodiments, other sensors, including optical sensors, could be used in place of the thermal sensor to detect the horizon.

Embodiments of the present invention described above provide several advantages, including the ability to detect both pitch and roll attitude using only one thermal sensor. Further, the use of a thermal sensor with a mirror or other deflector, allows the sensor to be mounted within the aircraft on a circuit board with other devices. The sensor may be mounted behind an IR transparent window to allow the sensor to be protected from the elements.

In embodiments of the invention described above, a thermal profile is detected at two positions (i.e., front and back) to determine pitch, and a thermal profile is detected at two positions (i.e., left and right) to determine roll. In other embodiments, changes in either roll or pitch are detected by viewing the same position at different times and detecting changes in the thermal profile indicating that the roll or pitch is changing.

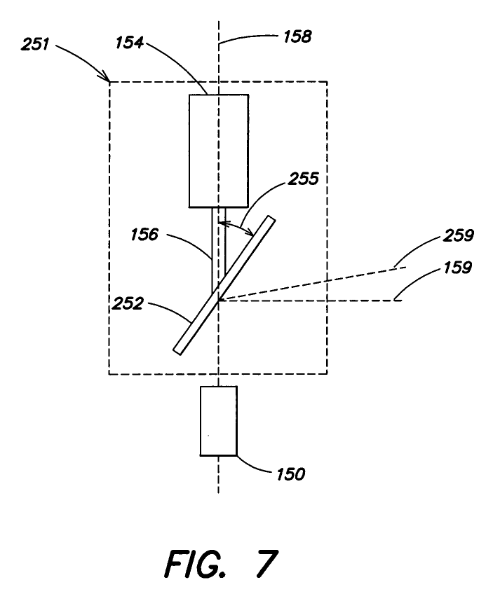

In embodiments described above, the angle of a mirror or deflector arranged to change the effective viewing axis of the thermal sensor is 45 degrees. As will now be explained, in other embodiments, the mirror or other deflector may be placed at an angle other than 45 degrees, and used in a system to limit roll attitude or pitch attitude. In one such embodiment, as shown in FIG. 7, a mirror assembly 251 is used in place of the mirror assembly 151. Common elements of mirror assemblies 151 and 251 are labeled with like references numbers. Mirror assembly 251 includes a mirror 253 placed at an angle 255 that is 40 degrees from the rotational axis of the mirror resulting in an effective viewing axis 259 of the thermal sensor that is ten degrees above the horizon during level flight of the aircraft. In this embodiment, the controller can compare temperature readings from the left side and right side of the aircraft to determine if the aircraft is in a left or right bank greater than 10 degrees, and if so, can use control surfaces or motors to correct the attitude. The use of the angled mirror to a preset angle allows the controller to correct attitude (pitch or roll) when an error in attitude is greater than a predetermined value. In other embodiments, mirror angles other than 40 degrees may be used. Further, in the embodiment described with reference to FIG. 7, the mirror is angled toward the sky to detect the sky during level (no roll or pitch) flight. In other embodiments, the mirror could be angled towards the earth to detect the earth during level flight.

In embodiments described above, the horizon sensing system is located on a longitudinal axis on the top of the aircraft. In other embodiments, the sensing system may be placed closer to either the front or rear of the aircraft, placed nearer the left or right side of the aircraft or placed on similar locations on the bottom of the aircraft. In embodiments described above, a sensor is positioned to have a viewing axis normal to both a transverse axis and a longitudinal axis of an aircraft. In other embodiments, the sensor may be positioned such that its viewing axis is parallel to one of the longitudinal axis and the transverse axis, and a diverter may still be used to create an effective viewing axis that is different from the viewing axis.

In embodiments described above, a mirror or other diverter is rotated to different positions to take thermal measurements at different positions. In at least one embodiment, the mirror or diverter may be rotated continuously with the sensor configured to take readings at preset times and/or locations, using, for example, devices and/or circuits to detect and calculate the position of the mirror.

In embodiments of the invention described herein, the terms longitudinal axis and transverse axis are used to describe aircraft. Depending on the particular type of aircraft such as a helicopter, the longitudinal axis may be along a portion of the aircraft that is not greater in length than the portion coinciding with the transverse axis.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A control system for a model aircraft having a longitudinal axis that extends from a rear of the aircraft to a front of the aircraft, the longitudinal axis being substantially parallel to a surface of the Earth when the aircraft is in level flight, the control system comprising:
a sensor having a viewing axis in a first direction that is substantially normal to the longitudinal axis;
a diverter constructed and arranged to divert the viewing axis of the sensor to provide an effective viewing axis in at least a second direction that is different from the first direction; and
a controller coupled to the sensor to receive output data from the sensor and adapted to provide output signals to control attitude of the model aircraft based on the output data.

2. The control system of claim 1, wherein the diverter is constructed and arranged to selectively provide an effective viewing axis in one of the second direction and a third direction that is different from the first direction and different from the second direction.

3. The control system of claim 2, wherein the second direction is along an axis normal to the viewing axis and the third direction is along an axis normal to the viewing axis.

4. The control system of claim 2, wherein the controller is configured to determine roll attitude of the aircraft based on output data from the sensor.

5. The control system of claim 2, wherein the controller is configured to determine pitch attitude based on output data from the sensor.

6. The control system of claim 2, wherein the diverter is constructed and arranged to selectively provide an effective viewing axis in a fourth direction and a fifth direction, with the second direction being opposite the third direction and the fourth direction being opposite the fifth direction.

7. The control system of claim 6, wherein the controller is configured to determine roll attitude and pitch attitude based on output data from the sensor.

8. The control system of claim 1, wherein the diverter includes a mirror that is rotatable to change direction of the effective viewing axis.

9. The control system of claim 8, wherein the controller is configured to provide output signals to control position of the mirror.

10. The control system of claim 3, wherein the sensor includes an infrared sensor.

11. A method of controlling a model aircraft comprising:
positioning a sensor on the aircraft such that a viewing axis of the sensor is in a first direction;
diverting the viewing axis of the sensor to provide a first effective viewing axis in a second direction that is different from the first direction;
diverting the viewing axis of the sensor to provide a second effective viewing axis in a third direction that is different from the first direction and the second direction;
capturing data from the sensor; and
controlling an attitude of the aircraft based on the data.

12. The method of claim 11, wherein the second direction is along an axis normal to the viewing axis and the third direction is along an axis normal to the viewing axis.

13. The method of claim 11, further comprising determining roll attitude of the aircraft based on data from the sensor.

14. The method of claim 11, further comprising determining pitch attitude of the aircraft based on data from the sensor.

15. The method of claim 11, further comprising:
diverting the viewing axis of the sensor to provide a third effective viewing axis in a fourth direction that is different from the first direction;
diverting the viewing axis of the sensor to provide a fourth effective viewing axis in a fifth direction that is different from the first direction and the second direction;
with the second direction being opposite the third direction and the fourth direction being opposite the fifth direction.

16. The method of claim 15, further comprising determining roll attitude and pitch attitude based on data from the sensor.

17. The method of claim 15, further comprising controlling roll attitude and pitch attitude based on data from the sensor.

18. The method of claim 11, wherein the sensor includes an infrared sensor.

19. A method of controlling a model aircraft using an infrared sensor mounted to the aircraft and a controllable mirror positioned along a viewing axis of the infrared sensor to control an effective viewing axis of the infrared sensor, the method comprising:
with the controllable mirror in a first position, detecting infrared energy using the infrared sensor;
moving the controllable mirror to a second position;
with the controllable mirror at the second position, detecting infrared energy using the infrared sensor; and
controlling attitude of the aircraft based at least in part on signals generated by the infrared sensor.

20. The method of claim 19, wherein at the first position, the effective viewing axis is in a first direction normal to the viewing axis, and at the second position, the effective viewing axis is in a second direction, opposite the first direction.

21. The method of claim 19, further comprising:
moving the controllable mirror to a third position;
with the controllable mirror at the third position, detecting infrared energy using the infrared sensor;
moving the controllable mirror to a fourth position;
with the controllable mirror at the fourth position, detecting infrared energy using the infrared sensor; and
controlling pitch and roll of the aircraft based at least in part on signals generated by the infrared sensor.

22. A model aircraft comprising:
a section having a longitudinal axis that extends from a rear of the aircraft to a front of the aircraft, the longitudinal axis being substantially parallel to a surface of the Earth when the aircraft is in level flight; and
a control system including:
an infrared sensor, mounted on the section and having a viewing axis in a first direction that is substantially normal to the longitudinal axis;
a controllable mirror constructed and arranged to divert the viewing axis of the infrared sensor to selectively provide an effective viewing axis in at least a second direction that is different from the first direction and a third direction that is different from the first direction and different from the second direction; and
a controller coupled to the infrared sensor to receive output data from the infrared sensor and adapted to provide output signals to control attitude of the model aircraft based on the output data.

23. The model aircraft of claim 22, wherein the controllable mirror is constructed and arranged such that the second direction is opposite the first direction to allow the infrared sensor to obtain infrared images of two opposite horizons when the aircraft is in level flight, and wherein the controller is configured to determine at least one of pitch attitude and roll attitude of the aircraft.

24. The model aircraft of claim 22, further comprising a mirror driver coupled to the controllable mirror to move the effective viewing axis between the first direction and the second direction, wherein the mirror driver is constructed and arranged to rotate the controllable mirror about an axis that is normal to the longitudinal axis.

25. The model aircraft of claim 24, wherein the mirror driver is constructed and arranged to rotate the controllable mirror to each of four rotational positions separated by approximately ninety degrees.

26. The model aircraft of claim 25, wherein the controller is configured to determine pitch and roll of the aircraft based on infrared data obtained for each of the four rotational positions of the controllable mirror.

27. The model aircraft of claim 24, wherein the controller is operatively coupled to the mirror driver to control movement of the controllable mirror.

28. The model aircraft of claim 22, further comprising a receiver coupled to the controller to receive signals from an operator to control operation of the model aircraft.

29. The model aircraft of claim 22, further comprising at least one wing coupled to the section.
